(19) United States
(12) Patent Application Publication
(10) Pub. No.: US 2007/0267295 A1
(43) Pub. Date: Nov. 22, 2007

(54) Apparatus and method for non-contact microfluidic sample manipulation

(76) Inventors: Hsueh-Chia Chang, Granger, IN (US); Diana Hou, Mishawaka, IN (US); Siddharth Maheshwari, South Bend, IN (US); Leslie Yeo, Hawthorn East (AU); Zachary Gagnon, Mishawaka, IN (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/436,436

(22) Filed: May 18, 2006

Related U.S. Application Data
(60) Provisional application No. 60/727,848, filed on Oct. 19, 2005.
(60) Provisional application No. 60/682,419, filed on May 19, 2005.

(51) Int. Cl. B01D 57/02

(52) U.S. Cl. 204/553; 204/643; 204/649

(57) ABSTRACT

An electro-hydrodynamic apparatus and method of using the same is disclosed. The electro-hydrodynamic apparatus includes a liquid sample supported on a substrate, with at least one electrode located proximate the surface of the liquid sample without contacting the liquid sample. A power supply creates an electric field proximate the surface of the liquid sample, thereby inducing a motion to the liquid sample. The apparatus may be used for focusing and separating particles within a liquid, and pumping and mixing a liquid sample or a liquid mixture with or without particles. The apparatus creates a primary rotational flow on a liquid surface to create a secondary inertial flow. The apparatus may be used to focus particles and/or pathogens to increase the sensitivity of current detection techniques and to enhance immuno-sensing techniques, as well as to mix heterogeneous components of a liquid sample by acting as a stirring without mechanical moving parts and to enhance antibody-antigen interactions, to pump liquids in lab-on-a-chip, clinical and environmental diagnostic kits, or to separate particles and/or pathogens by utilizing different dielectrophoretic mobilities, magnetic susceptibilities and/or antibody affinities.

### CROSS REFERENCE TO RELATED APPLICATION

This application is a non-provisional application claiming priority from U.S. Provisional Application Ser. No. 60/682,419, entitled “Microneedle Mixer and Separator,” filed May 19, 2005, and U.S. Provisional Application Ser. No. 60/727,848, entitled “Method for Non-Contact Microfluidic Sample Manipulation,” filed Oct. 19, 2005, each of which is incorporated herein by reference in their entirety.

### FIELD OF THE DISCLOSURE

The present disclosure relates generally to microfluidic tools utilizing electrokinetics, and more particularly, to apparatus and methods for non-contact microfluidic sample manipulation.

### BACKGROUND OF RELATED ART

On a micro-scale, alternating current (AC) and direct current (DC) electric fields can be used for concentrating, mixing, separating, and pumping liquid samples. For instance, S. C. Jakeway, A. J. de Mello, and E. L. Russel, Fresenius J. Anal. Chem. 366, 525, 2000, and D. J. Laser and J. G. Santiago, J. Micromech. Microeng. 14, R35, 2004, describe such tools for use in labs-on-a-chip, medical diagnostics, environmental sensors, and other test kits. In many cases, in order for an electrokinetic tool to provide the reproducible results that are necessary for commercial success, Joule heating and sample contamination from electrode reactions must be minimized or eliminated.

A drawback to most electrokinetic tools is that a large electrical current must be passed through the liquid sample to create strong convective electro-osmotic flows (i.e., movement of liquid relative to a stationary charged surface by an applied electric field) and/or to create strong electrophoretic/dielectrophoretic forces that are needed for rapid sample processing. For most electrode configurations a sufficiently large electrical current will lead to contaminating electrochemical reactions and Joule heating, both of which are highly undesirable. This is particularly problematic for biological and other samples that typically have high conductivities, requiring large currents to sustain strong electric fields or large gradients in electric fields. Hence, lower electrical currents must be used to minimize the contaminating reactions and Joule heating problems. However, lower electrical currents reduce the strength of the convective flow and electrophoretic/dielectrophoretic forces and therefore lead to longer processing times.

Nevertheless, AC and DC electric fields have been widely used in micro-fluidic devices, with limited operating parameters. For example, A. B. D Brown, C. G. Smith, and A. R. Rennie, PRE 64, 016305, 2000; A. Ajdari, PRE 61, R45, 2000; R. H. Liu, J. Yang, R. Lenigk, J. Bonanno, P. Grodzinski, Anal. Chem. 76, 1824, 2004, describe AC and DC electro-osmosis used to power micro-fluidic pumps. In another example, A. Ramos, H. Morgan, N. G. Green, and A. Castellanos, J. Electrost. 47, 71, 1999; J. Wu, Y. Ben, D. Battigelli, H. C. Chang, Ind. Eng. Chem. Res. 44, 2815, 2005; D. Lastochkin, R. Zhou, P. Wang, Y. Ben, H. C. Chang, J. Appl. Phys. 96, 1730, 2004, describes the use of convection from AC electro-osmosis for focusing particles and mixing liquid samples. In still another example, C. W. Kan, C. P. Fredlake, E. A. S. Dohety, A. E. Barron, Electrophoresis, 25, 3564, 2004 describes electrophoresis as a particle separation technique.

Additionally, D. Erickson, D. Li, Anal. Chim. Acta, 507, 11, 2004, describes capillary electrophoresis used as a particle separation technique and a pumping technique, while M. P. Hughes, H. Morgan, F. J., Rixon, J. P. H. Burt, R. Pethig, Biochim. Biophys. Acta, 1425, 119, 1998 describes dielectrophoresis used as a particle focusing and separation technique. As a final example, Gagnon, Z. and Chang, H.-C., “Aligning fast alternating current electroosmotic flow fields and characteristic frequencies with dielectrophoretic traps to achieve rapid bacteria detection”, Electrophoresis, 26, 3725-3737(2005), describes an alterative electrode configuration that utilizes dielectrophoresis and convection from AC electro-osmosis as a rapid particle focusing technique.

All of these applications of AC and DC electric fields typically have limited reasonable operating ranges where electrode reactions and Joule heating are negligible. Much faster processing times may be achieved if electrode reactions and Joule heating could be avoided.

### BRIEF DESCRIPTION OF THE DRAWINGS

FIG. 1 is a front perspective view of an example electro-hydrodynamic apparatus according to an embodiment of the present invention.

FIG. 2 is a plan view of the electro-hydrodynamic apparatus of FIG. 1.

FIG. 3 is another plan view of the electro-hydrodynamic apparatus of FIG. 1.

FIG. 4. is a cross-sectional view of the electro-hydrodynamic apparatus of FIG. 3, generally taken along the line 4-4.

FIG. 5A is a plan view of the electro-hydrodynamic apparatus of FIG. 1, showing an electrode in a first offset position.

FIG. 5B is a plan view of the electro-hydrodynamic apparatus of FIG. 1, showing an electrode in a second offset position.

FIG. 5C is a plan view of the electro-hydrodynamic apparatus of FIG. 1, showing an electrode in a third offset position.

FIG. 6 is a plan view of a plurality of particles focused at the stagnation region on the subrate in an embodiment of the apparatus of FIG. 1.

FIG. 7 is an exemplary flowchart, depicting one use of the apparatus of FIG. 1.

FIG. 8 is an exemplary flowchart, depicting another use of the apparatus of FIG. 1.

FIG. 9 is a front perspective view of another embodiment of an example electro-hydrodynamic apparatus.

FIG. 10. is a front perspective view of another embodiment of an example electro-hydrodynamic apparatus including a rapid particle manipulator.

### DETAILED DESCRIPTION OF AN EXAMPLE

The following description of the disclosed embodiment is not intended to limit the scope of the invention to the precise form or forms detailed herein. Instead the following description is intended to be illustrative of the principles of the invention so that others may follow its teachings.

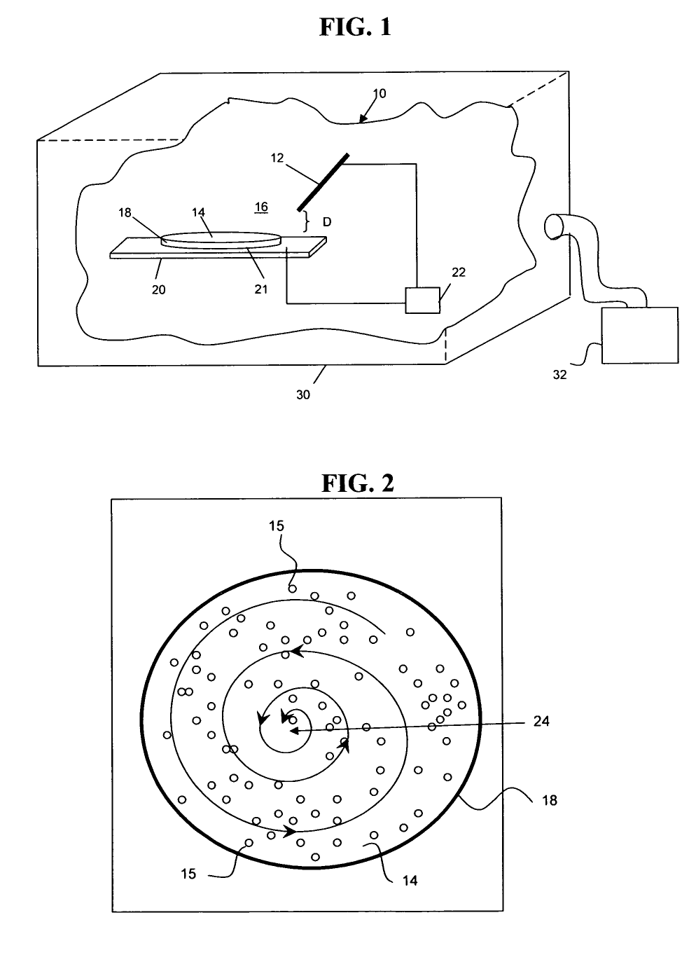

Referring now to the drawings, FIG. 1 is an illustration of an example microfluidic electro-hydrodynamic apparatus 10, constructed in accordance with the teachings of the present invention. In general, the microfluidic electro-hydrodynamic apparatus 10, may avoid significant Joule heating and contaminating electrochemical reactions by reducing the amount of electrical current that passes through the liquid sample. For instance, by aligning an electrode in the vicinity of the ambient medium/liquid sample interface, but not within the liquid sample, one can rapidly induce a flow that can be used for focusing, mixing, pumping, and/or separating a liquid sample or a component of a liquid sample, such as the particles contained in the liquid sample, with minimal and oftentimes negligible heating and contamination.

In the illustrated embodiment, an electrode, such as a sharp electrode 12, is separated from the surface of a liquid sample 14 by a distance D. The sharp electrode 12 may be any electrode, such as an electrode with an abrupt or singular geometry such that under an applied potential, a high electric field is generated at the abrupt or singular geometry to undergo gas-phase ionization, the ionization of molecules of the ambient media near a high field region, leading to the generation of free charges. However, it will be appreciated by one of ordinary skill in the art that the electrode may be any suitable electrode, including an electrode of differing geometry (i.e., non-sharp). Furthermore, the electro-hydrodynamic apparatus 10 may include any number of electrodes, or other device capable of, either singularly or in combination, producing an electric field above the surface of the liquid sample 14. The liquid sample 14 may contain at least one particle 15, such as, for instance, a solid particle, liquid drop, air bubble, bacteria, virus, blood cell, biological material, parasite, cancer cell, protein, DNA, chemical compound, or any other particle.

In the illustrated embodiment of FIG. 1, the sharp electrode 12 is separated from the surface of the liquid sample 14, by the distance D of approximately 0.5 millimeters to approximately 5 centimeters. It will be appreciated by one of ordinary skill in the art, however, that the distance D may vary according to design. Also in this example, the gap between the sharp electrode 12 and liquid sample 14 comprises an ambient medium 16. The ambient medium 16 may be any medium outside the sample liquid 14 that is not miscible with the sample liquid 14. The ambient medium 16 is most likely a gas, but not limited to a gas. Furthermore, the ambient medium 16 may be a vacuum.

The liquid sample 14 may be contained within a bounding side wall 18. Near the liquid sample 14, and in the case of the present embodiment in contact with the liquid sample 14, supported by a substrate 20, which, in the present example, includes an embedded electrode 21. Electrically coupled to at least one of the electrode 12, the substrate 20, or the electrode 21 is a power supply 22. In this example, the power supply 22 is electrically coupled to both the electrode 12, and the electrode/substrate 20. The power supply 22 may generate an electric field that has a path comprising at least some distance through each of the electrode 12, the ambient medium 16, the liquid sample 14, and the substrate 20.

Referring to FIG. 2, the application of an electric field to the liquid sample 14 having at least one particle 15 may impart motion to the particles 15. The motion is predominantly a consequence of convection in the liquid sample 14 caused by the application of the electric field. By visually tracking the motion of the particles 15 with a high performance microscope, the direction and magnitude of the convective flow has been found for an array of different operating parameters. The particles 15 suspended in the liquid sample 14 are observed to spiral in toward a stagnation region 24 near the liquid sample/substrate interface as can be seen in FIG. 2. The stagnation region refers to the region at which a recirculating liquid sample no longer acts to transport particles via convection. Stagnation regions generally develop at and near where the liquid sample velocity is zero.

In general, particles in a liquid sample are often drawn to and trapped in stagnation regions by a body force such as gravity or a short-range adhesive force. When the force is dielectrophoresis, stagnation regions may be used to differentiate between particles that suffer positive dielectrophoresis from those that suffer negative dielectrophoresis. Similarly, when gravity is the force, differences in the buoyancy of the particles allows for rapid separation in the presence of a stagnation region. Dielectrophoresis refers to the motion of neutral matter caused by polarization effects in a non-uniform electric field. Positive dielectrophoresis refers to the motion of particles to high field regions. Negative dielectrophoresis refers to the motion of particles to low field regions.

For certain configurations of the present disclosure, there may be multiple stagnation regions 24. The characteristics of the local convective flow that is centered about a given stagnation region 24 can most easily be understood for the case when there is only one significant stagnation region 24 generated by the electro-hydrodynamic apparatus 10. When this occurs, there are two additive flows in the liquid sample 14 that are centered about the single significant stagnation region 24.

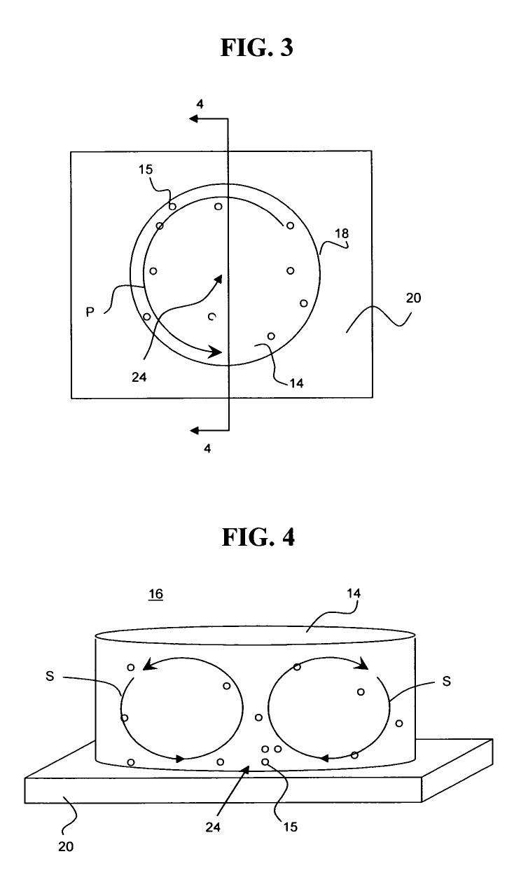

As illustrated in FIG. 3, the primary convective flow (illustrated by the arrow P) is a rotational path due to the back pressure resulting from the bounding side walls/free surface. In this embodiment, the flow P is a vortex flow centered about the stagnation region 24. As shown in FIG. 4, at sufficiently high rotation rates, at least one secondary flow (illustrated by the arrows S) may be generated. The secondary flows S are generally radially outward near the top ambient medium 16 and liquid sample 14 interface and radially inward near the bottom liquid sample 14 and substrate 20 surface. The secondary flows S, although usually much weaker than the primary flow P, convects the liquid sample 14 and any particles 15 it contains toward the stagnation region 24.

It is speculated that upon application of the electric field, the ambient medium 16 surrounding the electrode 12 is polarized and ultimately free ions are generated. Under the influence of the electric field, these ions may be transported to the surface of the liquid sample 14. The applied electric field may cause these ions to move on the surface of the liquid sample 14. The motion of the ions may induce motion, for example flow P, in the surface of the liquid sample 14 as well. Ultimately the transport of the momentum may then cause the entire liquid sample 14 to move, such as for example flow P and flow S.

The suspended particles 15 follow the streamline flow P to the stagnation region 24 near the liquid sample 14 and substrate 20 interface. As the flow P converges towards the stagnation region 24, to preserve volume, the liquid sample 14 must be displaced upwards and recirculated. Near the stagnation region 24, the convective forces on the particles are reduced due to the lower velocity very close to the stationary substrate. Hence body forces, such as gravitational forces, magnetic forces, electrophoretic/dielectrophoretic forces, and/or short range adhesive forces can draw them to the stagnation region 24 and prevent them from being resuspended into the liquid sample 14. Thus, this converging flow P coupled with a force creates a stable stagnation region 24 for particle focusing. As the geometry of the stagnation region 24 is generally a point instead of a line, the efficiency of particle 15 trapping is generally enhanced.

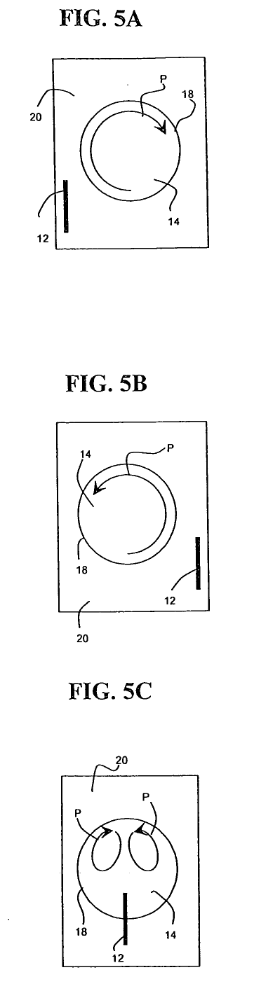

As illustrated in FIGS. 5A-5C, the placement of the electrode 12 offset from the liquid sample 14 itself may generate liquid motion (flow P) in one direction or the other, depending upon the placement of the electrode 12, over the surface of the liquid sample 14. Moreover, depending upon the inclination and location of the electrode 12, the electric field lines distribution changes, enabling control over the number of vortices and consequently the number of stagnation regions 24, and the magnitude and direction of the convective flow(s).

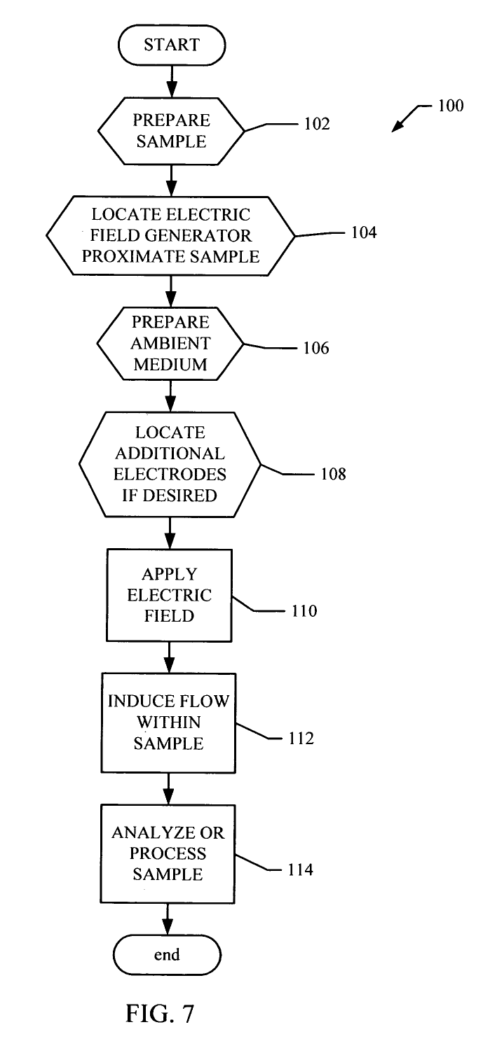

The electrode 12 may be made of a metal or any other suitable conducting material. It may be, for example, a strip of suitable size, a micro-needle, a syringe tip micron-needle, a hypodermic micro-needle, a spray head, a nozzle, a tube, a metallic conical tip, a glass or plastic capillary with electrode connections, or other shapes of similar geometries. Additionally, the electrode 12 may be placed above the surface of the liquid sample 14 at any inclination relative to the horizontal, including for instance, at an inclination of between 0° and 90°. The electrode 12 and/or the substrate 20 may be housed within a top or side containing wall (not shown) of a totally or partially enclosed channel or reservoir (not shown). In one embodiment, the aspect ratio and sharpness of this electrode 12 depends on the magnitude of the electric field applied. For example, in one embodiment, for an applied field of 3 kV the electrode may be approximately less than 500 microns in the smaller dimension. Additionally, multiple electrodes 12 may also be present (see FIG. 7).

A typical liquid sample 14 may include suspensions of particles 15 as described above. Several experiments have been conducted with a number of liquids with different relative conductivities, permittivities and particle concentrations: deionized water, phosphate buffer solution, tryptic soy broth, ethanol, dielectrics, electrolytes, physiological fluids, or mixtures thereof comprising single or multiple phases. The performance of the electro-hydrodynamic apparatus 10 did not change as a function of the liquid sample 14 conductivity, permittivity, or the particle 15 concentration. As disclosed, the electrode 12 is not in contact with the liquid sample 14 and there is minimal current within the liquid sample 14. This may be considered a tremendous advantage over prior art, where high liquid sample conductivities and large currents between electrodes immersed within the liquid sample lead to electrode reactions and Joule heating even when these electrokinetic tools are used to generate slow flows and weak electrophoretic/dielectrophoretic forces.

Several experiments have been conducted with the electro-hydrodynamic apparatus 10 with a number of particles 15 of different size and composition: 1 micron; 5 micron; 10 micron; 15 micron latex spheres; functionalized latex spheres; alumina micro-spheres; E. coli; yeast; and/or mixtures thereof. In general, the liquid sample 14 may contain any arbitrary particle and the electro-hydrodynamic apparatus 10 will still function properly. Reasonable particles 15 that may be part of the liquid sample 14 in one embodiments, may be but are not limited to colloids, red blood cells, bacteria, viruses, and functionalized magnetic beads.

Furthermore, air is not the only ambient medium 16 that can be used in the conjunction with the present electro-hydrodynamic apparatus 10. It will be appreciated by one of ordinary skill in the art that other gases, immiscible liquids, and/or a vacuum may also be employed. During the operation of the electro-hydrodynamic apparatus 10, the ambient medium 16 may sometimes become plasma. In one embodiment, the ambient medium 16 may include air, vacuum, trace gas, argon, helium, neon, ozone, organic liquids, or other similar media. To accommodate the use of various ambient media, the entire electro-hydrodynamic apparatus 10, or at least the liquid sample 14, the electrode 12, and the ambient medium 16, may be housed in a chamber, such as a sealed chamber 30 connected to a vacuum pump 32 or to inlet/outlet gas/liquid ports.

The bounding side walls 18 may be present, but this is not a necessary condition for operation as the flow effects can also be observed with a free bounding liquid sample surface. If present, the bounding side walls 18 may be inclined relative to the bottom substrate 20 at an angle from 0 degrees to 90 degrees, and may additionally be flat, straight, curved, periodic, or any other suitable geometry.

The bottom substrate 20 may contain one or more electrodes, such as a second electrode 21, which may be in contact with the liquid sample 14, exposed on the surface of the substrate 20 but not in contact with the liquid sample 14, and/or embedded in the substrate 20 such that there is no electrical contact with the liquid sample 14. The location of the second electrode 21 with reference to the liquid sample 14 may be such that it ensures that at least some of the electric field lines penetrate the liquid sample 14. The substrate 20 may be made of any suitable solid. The second electrode 21 may be constructed of any suitable conductor such as, for example, a metal such as gold and/or platinum. Furthermore, multiple electrodes 21 may be used to generate electrophoretic and/or dielectrophoretic forces if they are desirable for a particular application. For example, in one embodiment, the electrode 21 may coincide with the stagnation region 24 so as to provide a force on the particles 15 for focusing applications. The bottom substrate 20 may be a flat strip or any other suitable shape such as, for example, bowl-shaped and/or conical. The second electrode 21 may additionally assume any geometry, such as, for instance, spiral-shaped, flat, bowl-shaped, conical, serpentine, and/or any other suitable geometry.

In an embodiment of the present electro-hydrodynamic apparatus 10, the power supply 22 is an alternating-current (AC) source. The operating window ranges from approximately 5V to approximately 50 kV at frequencies ranging from approximately 1 Hz to approximately 1 MHz. Other suitable alternating current sources for use in embodiments of the electro-hydrodynamic apparatus 10 include units that can be used to generate all possible waveform including signals such as sine waves, saw-tooth waves, square waves, trapezoidal waves and/or triangle waves, amongst others.

In another embodiment of the electro-hydrodynamic apparatus 10, the power supply 22 may be a direct-current (DC) source, operating from approximately 5V to approximately 50 kV.

The electro-hydrodynamic apparatus 10 may have advantages relative to prior art because the current passed through liquid sample 14 is typically small even for the highest velocities. Thus, the electro-hydrodynamic apparatus 10 may minimize bubble and/or ion generation due to electrode reaction and Joule heating. Therefore, the voltage drop can reach several kV and the electrostatic force being transmitted to the liquid sample 14 may be several orders of magnitude higher than that of the prior art.

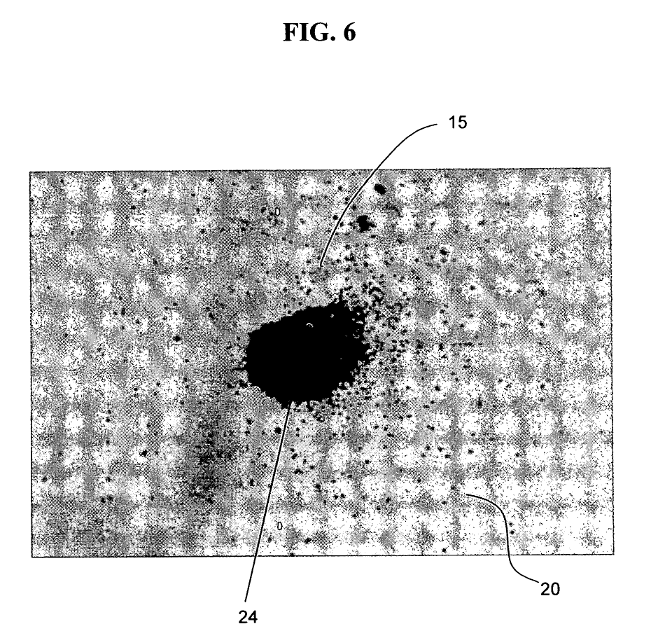

In one embodiment the observed convective flows P and/or S may be utilized to trap and/or focus the particles 15 on the stagnation region 24 in a relatively short amount of time. This focusing is observed to concentrate at the stagnation region 24 located at the center of the vortex near the liquid sample 14 a substrate 20 interface, as seen in FIG. 6. In the disclosed method, a liquid sample 14 including at least one particle 15 is placed in the electro-hydrodynamic apparatus 10. The electrode 12, or other suitable device, is utilized to generate an electric field over the liquid sample 14, initializing convective flow within the sample 14. As the particles 15 concentrate, the concentration in the bulk liquid sample 14 is noticeably reduced. The particle 15 concentration is not limited to a single location, rather, depending upon the placement of the electrode 12, multiple vortices, and stagnation regions 24 can be observed. Upon the addition of a dye or a separate liquid phase it has also been observed that the dye/liquid phase is rapidly distributed throughout the liquid sample 14 volume, indicating that the electro-hydrodynamic apparatus 10 could be used to mix. Separation of a mixture of particles 15 or removal of all of the particles 15 from a suspension may be also be achieved, wherein particles 15 with specific properties will either be focused on the stagnation region 24 or remain suspended in the liquid sample 14.

The focusing of particles 15 at a predicted location provides the ability for rapid detection of the particles 15. The focusing of particles 15 can be used to amplify the signal used to detect pathogens in clinical/environmental samples. A pathogen may refer to any bacteria, viruses, parasites, cancer cells, etc. Current standards require laboratory culturing and cell counting of the pathogens due to their low concentrations, which can take hours to days to process. The pathogens rapidly concentrated at the pre-determined stagnation region 24 can be quantified and identified with non-invasive detection techniques. Alternatively, a small flow from the stagnation region 24 can be extracted during or after the concentration process to elute a sample volume smaller than the original with a higher pathogen concentration. The pathogen in the eluted volume can be quantified and detected by both invasive and non-invasive detection techniques. The higher pathogen concentration produced by focusing of particles at the stagnation region reduces the processing time for many detection methods by increasing the sensitivity of these current detection techniques, such as optical, impedance, fluorescence, PCR, etc.

The electro-hydrodynamic apparatus 10 may also be used to enhance immuno-sensing techniques. For example, immobilizing antibodies at the predetermined stagnation region 24 where the bioparticles are focused enhances interactions among them, thus increasing the probability of antibody-antigen docking. Varying the electrode 12 location and the number of electrodes used allows bioparticles to concentrate at different pre-determined stagnation regions 24, each of which can have different antibodies immobilized at the surface. Thus, the electro-hydrodynamic apparatus 10 can perform identification and characterization of multiple pathogens present in a sample in a single processing step. Immuno-assay can also be applied to the concentrated pathogen population within any eluted volume from the stagnation region 24.

Thus, according to one embodiment of the present invention, there is provided a method of rapid particle focusing, illustrated in FIG. 7, and generally referred to as reference numeral 100. In the disclosed focusing method 100, a liquid sample 14 containing at least one particle 15 is prepared by supporting the liquid sample 14 on a substrate 20 (block 102). An electrode 12, or other device capable of generating an electric field, is located proximate the surface of the liquid sample 14 (block 104). The electrode 12 may be separated from the liquid sample 14 by an ambient medium 16 (block 106). As disclosed above, any suitable medium may be used, including the ambient air naturally found around the sample 14. In one example, additional electrodes, including the second electrode 21 may be provided, such as, for example, on or below the substrate 20 (block 108). The power source 22 may be coupled to the electrode 12 and utilized to generate an electric field (block 110) to induce at least one primary rotational flow P and/or secondary flow S in the liquid sample 14 centered about a stagnation region 24 (block 112). Finally, the liquid sample 14, and in particular, the particles 15 (or lack thereof) in the stagnation region 24, may be analyzed according to typical contact and/or non-contact analyzing methods to determine the desired analytical results (block 114).

The electro-hydrodynamic apparatus 10 may also be used as a rapid mixer for particles, liquids, multiphase liquid samples and mixtures thereof. Despite their small length scales, the miniscule diffusivities of protein and drug compounds stipulate that most reactions/biochemical docking are diffusion limited with excessively high diffusion times. Stirring and mixing with moving parts are not possible in micro-fluidic devices. Non-contact electro-hydrodynamic mixing provided by the electro-hydrodynamic apparatus 10 allows for rapid mixing with no moving parts, making it suitable for micro-fluidic devices.

A rapid mixing technique of the electro-hydrodynamic apparatus 10 involves taking advantage of the flow that is observed in the liquid sample 14 upon the application of an electric field. The high velocities induced by the rotational flow of the electro-hydrodynamic apparatus 10, generally stir, on a microscale, with the equivalent effectiveness of a mechanical mixer on a larger scale. The heterogeneous components can be composed of particles, liquids, drops, bubbles and/or multiphase liquids. A rapid micro mixer can also enhance the rate of antibody-antigen interactions in immunoassay (viz. magnetic bead) techniques.

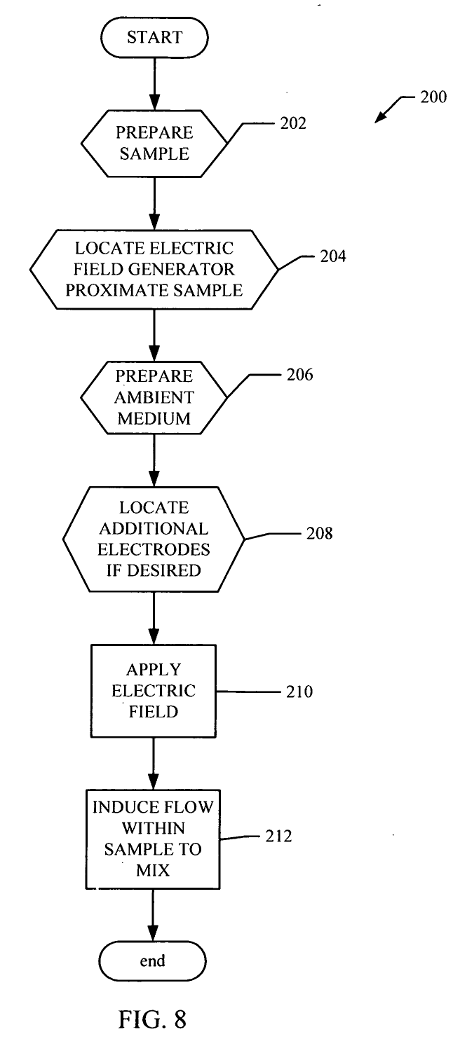

Thus, according to another embodiment of the present invention, there is provided a method of rapid particle and/or liquid mixing, illustrated in FIG. 8, and generally referred to as reference numeral 200. In the disclosed mixing method 200, a liquid sample 14 is prepared by supporting the liquid sample 14 on a substrate 20 (block 202). The liquid sample 14 may contain at least one particle 15, different liquids, multiphase liquids, drops, bubbles, and/or other material. An electrode 12, or other device capable of generating an electric field, is located proximate the surface of the liquid sample 14 (block 204). The electrode 12 may be separated from the liquid sample 14 by an ambient medium 16 (block 206). As disclosed above, any suitable medium may be used, including the ambient air naturally found around the sample 14. In one example, additional electrodes, including the second electrode 21 may be provided, such as, for example, on or below the substrate 20 (block 208). The power source 22 may be coupled to the electrode 12 and utilized to generate an electric field (block 210) to induce at least one primary rotational flow P and/or secondary flow S in the liquid sample 14 centered about a stagnation region 24 (block 212), mixing the contents of the liquid sample.

The electro-hydrodynamic apparatus 10 may also be used as a rapid particle separator. For example, a selective trap (not shown) such as a dielectrophoretic trap, a trapping magnetic field, an antibody functionalized surface, and/or other suitable trap, can be placed at the stagnation region 24 to selective separate particles 15 of different dielectrophoretic mobility, magnetic susceptibility, and/or antibody affinity. Other selective traps using difference in shear-induced migration rate, size, specific density, etc can also be placed at the stagnation region 24 to achieve separation. The separation of particles 15 is of utility to several applications, including the isolation of a target particle from a heterogeneous mixture or the removal of all of the particles from a suspension. For example, red blood cells could be removed from whole blood. Another specific application is that species that interfere with or foul biosensors may be removed, thus reducing false positives/false negatives, increasing the specificity of the biosensor.

A rapid particle separation technique of the present invention involves inducing a rotational motion in the liquid sample with an electric field. Utilizing differences in size, conductivity, permittivity, buoyancy, and/or other property, specific particles 15 can be trapped either at the bottom of the vortex or remain suspended in the liquid 14. Another basis for separation is differences in dielectrophoretic properties. In practice, this is accomplished by placing one or more circuits near the bottom of the substrate and operating each of the circuit(s) at a specific frequency. Depending upon the cross-over frequencies of the particles, they will suffer either positive or negative dielectrophoresis at each respective electrode, which will determine the resulting location of the particles 15. The cross-over frequency refers to the frequency where a particle will switch from positive dielectrophoresis to negative dielectrophoresis and vice versa. Different separation can hence be achieved by using different frequency at the dielectrophoretic trap. Thus, by applying a trap in the stagnation region 24 there is provided a method of rapid particle separation.

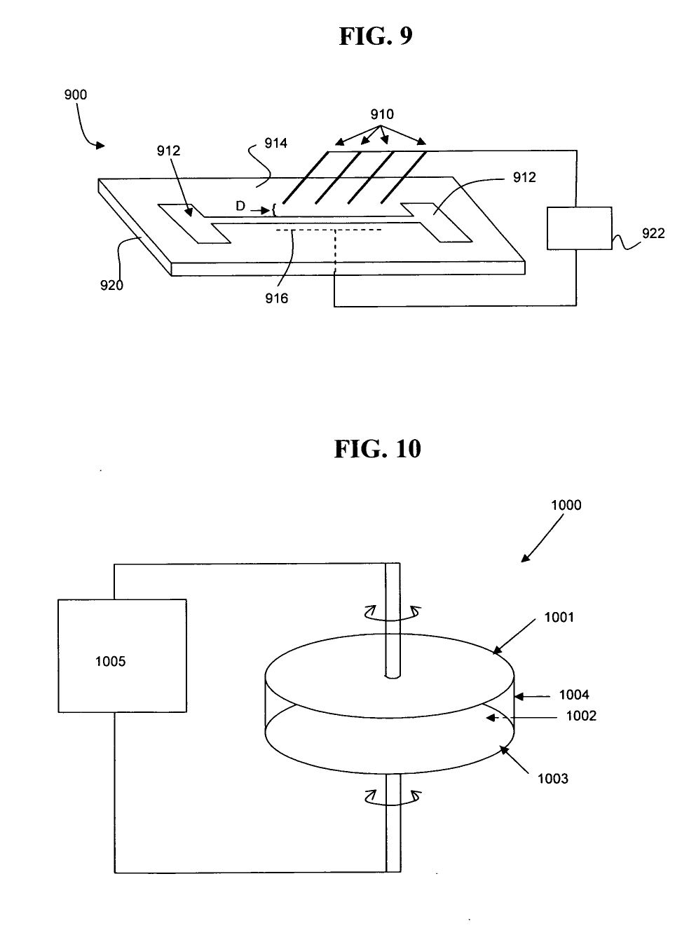

In another embodiment illustrated in FIG. 9, another electro-hydrodynamic apparatus 900 may be used as a micro-fluidic pump and valve to enhance transport rates in lab-on-a-chip, and/or clinical and environmental diagnostic kits. Specific configurations of multiple electrodes along the micro-fluidic channels enable the transport of momentum in a specific direction, thus making it possible to move the liquid to a desired location.

For example, in the disclosed embodiment, an array of electrodes 910, for example sharp electrode, is separated from the surface of a liquid sample 912 by a distance D. An ambient medium 914 may fill the gap created between the electrode array 910 and the surface of the liquid sample 912. Proximate the liquid sample 912, and in the case of the present embodiment in contact with the liquid sample 912, there may be a second electrode 916. Supporting the liquid sample 912 is a substrate 920, which in the case of the present embodiment also houses the second electrode 916. A power supply 922 is used to generate an electric field that generally has a path at least some distance through each of the electrodes 910, the ambient medium 914, the liquid sample 912, and the second electrode 916.

The electrodes 910 may be assembled in a linear array (as shown) or multiple-row arrays embedded in the top wall or the side wall of the flowing channel or outside the channel. The electrode array 910 is not in contact with the liquid sample 912. To achieve flow in a particular longitudinal direction, the inclination of each electrode 912 may be in the same direction. The electrode arrays 912 are not immersed in the flowing phase but are only in the ambient medium 914, typically a gas phase that is not miscible with and separated from the flowing phase. To arrest liquid motion, the field on each of the local electrodes 910 may be turned off such that no more force is imparted to produce flow. To direct flow to different channels at a channel junction or bifurcation, different electrodes 910 with different inclinations can be activated to direct flow in specific direction. The pumping flow does not necessarily have a stagnation flow region

The utilization of each of the disclosed electro-hydrodynamic apparatuses with a stagnation flow region is generally complementary with the creation of rotational flow(s) in the liquid which can induce secondary flow(s). Hence, any technique that can create similar rotational motion on the liquid surface can also be used for all the above mentioned applications. The trapping and separation applications can be achieved at this stagnation zone by gravity, by additional circuits for generating an electrophoretic/dielectrophoretic force and other traps placed at the stagnation region as some of the methods require.

One alternative way of inducing a vortex flow is by contacting the liquid surface with a rotating surface, something that is commonly used in viscosity measurements. However, in viscosity measurements the induced secondary flows may be detrimental for the purpose of making accurate measurements, thus the secondary flows are minimized. These secondary flows that have long been considered problematic actually provide a useful tool for particle manipulation, as can be seen by the applications described below. Hence, by using a rotating surface in contact with a liquid sample, the liquid sample or a subset of the liquid sample can be focused, mixed, and/or separated.

Another alternative embodiment of an electro-hydrodynamic apparatus 1000, constructed in accordance with the teachings of the present invention is shown in FIG. 10. For example, a surface 1001 is brought in contact with a liquid sample 1002 on the top and a surface 1003 is in contact with the liquid sample 1002 on the bottom. The liquid sample 1002 is contained within bounding side walls 1004. Either the surface 1001 and/or the surface 1003 can be rotated. The liquid sample 1002 is comprised of at least one liquid, and is may be comprised of at least one liquid and at least one particle. A motor 1005 is coupled to either surface 1001 and/or surface 1003 to impart rotational motion to the surface and liquid assembly. By momentum transfer, the rotational motion is transferred to the liquid sample 1002 to generate a rotational flow and the said secondary flow.

The liquid sample 1002 may be contained within the bounding side walls 1004, however, the flow effects can also be observed with a free bounding surface. If present, the bounding side walls may be inclined relative to the bottom 1003 and/or top 1001 surfaces at an angle from 0 degrees to 90 degrees, curved, periodic, and/or any other reasonable geometries.

Thus, the electro-hydrodynamic apparatus 1000 may provide a method of rapid particle focusing, concentrating and separation, including providing a top surface 1001 comprised of a solid such as metal, glass, or plastic, providing a bottom surface 1003 comprised of a solid such as metal glass, or plastic and providing a liquid sample 1004 between the top surface 1001 and the bottom surface 1003. The liquid sample 1004 may contains at least one particle. The motor 1005 imparts a rotation to the top surface 1001 and/or the bottom surface 1003 to induce at least one primary rotational flow in the liquid sample 1004 that then induces a secondary flow in the liquid sample 1004 centered about a stagnation region.

All documents, patent, journal articles and other materials cited in the present application are hereby incorporated by reference.

Although the teachings of the invention have been illustrated in connection with certain embodiments, there is no intent to limit the invention to such embodiments. On the contrary, the intention of this application is to cover all modifications and embodiments fairly falling within the scope of the appended claims either literally or under the doctrine of equivalents.

We claim:

1. An electro-hydrodynamic apparatus comprising:
a substrate;
a liquid sample supported by the substrate;
an electrode located proximate the surface of the liquid sample without contacting the liquid sample; and
a power supply electrically coupled to the electrode, to create an electric field proximate the liquid sample, thereby inducing a motion to the liquid sample.

2. An electro-hydrodynamic apparatus as defined in claim 1, further comprising a second electrode coupled to the substrate and located such that the electric field generated extends between the electrode and the second electrode, and extends through the liquid sample.

3. An electro-hydrodynamic apparatus as defined in claim 2, wherein the second electrode is in contact with the liquid sample.

4. An electro-hydrodynamic apparatus as defined in claim 1, wherein the electrode is a sharp electrode.

5. An electro-hydrodynamic apparatus as defined in claim 1, wherein the power supply is one of an alternating-current or a direct-current power supply.

6. An electro-hydrodynamic apparatus as defined in claim 1, wherein the power supply has a frequency range between approximately 1 Hz and approximately 1 MHz.

7. An electro-hydrodynamic apparatus as defined in claim 1, wherein the power supply has a peak-to-peak voltage range between approximately 5 V and approximately 50 kV.

8. An electro-hydrodynamic apparatus as defined in claim 1, further comprising an ambient medium between the surface of the liquid sample and the electrode.

9. An electro-hydrodynamic apparatus as defined in claim 8, wherein the ambient medium is at least one of air, a vacuum, a trace gas, helium, argon, neon, or ozone.

10. An electro-hydrodynamic apparatus as defined in claim 8, further comprising a chamber enclosing at least the electrode, the liquid sample, and the ambient medium.

11. An electro-hydrodynamic apparatus as defined in claim 1, wherein the induced motion is centered about a stagnation region.

12. An electro-hydrodynamic apparatus as defined in claim 1, wherein the induced motion includes both a primary rotational flow generally parallel to the surface of the liquid sample, and a secondary flow generally perpendicular to the surface of the liquid sample.

13. An electro-hydrodynamic apparatus as defined in claim 1, wherein the substrate includes at least one bounding wall to support the liquid sample.

14. An electro-hydrodynamic apparatus as defined in claim 13, wherein the at least one bounding wall includes at least one electrode.

15. An electro-hydrodynamic apparatus as defined in claim 1, wherein the liquid sample includes a plurality of particles.

16. An electro-hydrodynamic apparatus as defined in claim 15, wherein the induced motion is centered about a stagnation region.

17. An electro-hydrodynamic apparatus as defined in claim 1, wherein the electrode is shiftable to incline between approximately zero to approximately ninety degrees from horizontal.

18. An electro-hydrodynamic apparatus as defined in claim 1, further comprising a trapping device to trap any particle contained within the liquid sample.

19. An electro-hydrodynamic apparatus as defined in claim 18, wherein the trapping device is a circuit to trap any the particle via electrophoresis/dielectrophoresis.

20. An electro-hydrodynamic apparatus as defined in claim 1, wherein the electric field creates plasma proximate the surface of the liquid sample.

21. An electro-hydrodynamic apparatus as defined in claim 1, wherein the liquid sample includes at least one of deionized water, dielectrics, electrolytes, physiological fluids or mixtures thereof comprising single or multiple phases.

22. An electro-hydrodynamic apparatus as defined in claim 1, further comprising a motor coupled to the substrate to rotate the substrate about an axis.

23. An electro-hydrodynamic apparatus as defined in claim 22, wherein the motor is coupled to at least one of the top or bottom of the substrate.

24. An electro-hydrodynamic apparatus comprising:
a substrate;
a liquid sample supported by the substrate and including at least one particle;
electrode means for creating a electric field proximate the liquid sample and for inducing a motion to the liquid sample without contacting the surface thereof; and
a power supply electrically coupled to the electrode means.

25. An electro-hydrodynamic apparatus as defined in claim 24, wherein the electrode means comprises a first electrode

26. An electro-hydrodynamic apparatus as defined in claim 25, wherein the second electrode contacts at least a portion of the liquid sample.

27. An electro-hydrodynamic apparatus as defined in claim 26, further comprising an ambient medium between the surface of the liquid sample and electrode means

28. An electro-hydrodynamic apparatus as defined in claim 24, wherein the electrode means includes at least one sharp electrode.

29. A method of inducing motion in a liquid sample comprising:
supporting a liquid sample including at least one particle by a substrate;
providing an electrode proximate the liquid sample and separated from the liquid sample by an ambient medium;
generating an electric field above the surface of the liquid sample; and
inducing at least one primary rotational flow in the liquid sample centered about a stagnation region.

30. A method as defined in claim 29, further comprising inducing a secondary flow in the liquid sample.

31. A method as defined in claim 29, further comprising proving a second electrode spaced away from the first electrode such that at least a portion of the liquid sample is between at first electrode and the second electrode.

32. A method as defined in claim 29, further comprising generated the electric field with at least one of an alternating-current power source or a direct-current power source.

33. A method as defined in claim 29, further comprising generated the electric field with a power source having a frequency range between approximately 1 Hz and approximately 1 MHz.

34. A method as defined in claim 29, further comprising generating the electric field with a power source having a peak-to-peak voltage range between approximately 5V and approximately 50 kV.

35. A method as defined in claim 29, further comprising analyzing the liquid sample

36. A method as defined in claim 35, further comprising analyzing at least one particle located near the stagnation region.

37. A method as defined in claim 29, further comprising mixing the liquid sample.

38. A method as defined in claim 29, further comprising separating at least one particle from the liquid sample.

39. A method as defined in claim 38, further comprising trapping at least one particle from the liquid sample.

40. A method as defined in claim 29, further comprising embedding a second electrode in the substrate such that at least a portion of the liquid sample is between the first electrode and the second electrode.

41. A method as defined in claim 29, further comprising providing an ambient medium of at least one of air, a vacuum, a trace gas, helium, argon, neon, or ozone.
